(19) United States
(12) Patent Application Publication
(10) Pub. No.: US 2009/0039642 A1
(43) Pub. Date: Feb. 12, 2009

(54) APPARATUS-INFORMATION INDICATOR, LABEL SHEET, AND ELECTRONIC APPARATUS AND IMAGE FORMING APPARATUS HAVING THE SAME

(75) Inventors: Masuo Kawamoto, Osaka-shi (JP); Takaya Akiyama, Osaka-shi (JP); Yoshiyuki Asakawa, Osaka-shi (JP); Hideki Takeda, Osaka-shi (JP); Ikuo Sugimoto, Osaka-shi (JP); Yasuo Nakamura, Osaka-shi (JP); Hiroshi Ito, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/185,180

(22) Filed: Aug. 4, 2008

(30) Foreign Application Priority Data
Aug. 8, 2007 (JP) 2007-206525

(51) Int. Cl. B65C 1/02; G03G 15/00; B41J 2/52

(52) U.S. Cl. 283/70; 347/251

(57) ABSTRACT

Disclosed is an apparatus-information indicator, which includes an indication surface, an underlying segment formed on the indication surface by a first dot pattern, and a character area formed on the underlying segment by a second dot pattern different from the first dot pattern to indicate given apparatus information. Respective colors of the underlying segment and the character area are substantially equal in hue, and substantially different in lightness.

### BACKGROUND OF THE INVENTION

1. Field of the Invention

The present invention relates to an apparatus-information indicator or a label sheet adapted to be used for indicating information about an apparatus (hereinafter referred to as “apparatus information”), such as names of a manufacturer, a distributor and a repair company, a product name, a model name, performances, functions, specifications, an operation procedure, a procedures for coping with each malfunction, and a disposal procedure, which are associated with the apparatus. The present invention also relates to an electronic apparatus and an image forming apparatus having the apparatus-information indicator or the label sheet in an affixed manner.

2. Description of the Related Art

In an apparatus, such as an image forming apparatus typified by a copying machine or a printer, it is commonly performed to indicate on an exterior cover thereof apparatus information, such as names of a manufacturer, a distributor and a repair company, a product name, a model name, performances, functions, specifications, an operation procedure, a procedure for coping with each malfunction, and a disposal procedure, which are associated with the apparatus. For example, a technique of forming print or irregularities directly on a component (e.g., exterior cover) of an apparatus, or a technique of affixing a label sheet printed with the apparatus information, to a component of an apparatus using an adhesive or a bonding member such as a double-sided bonding tape, is employed to indicate the apparatus information.

An example of such an indication given to an apparatus can be seen in Japanese Patent No. 3569033 (D1) and Japanese Patent No. 3744858 (D2). Specifically, the document D1 discloses a product having a recyclable component, wherein a decal having a mark described therein to indicate that the component can be subjected to a recycle process without peeling the decal therefrom, and a sheet-shaped member indicating the detail of a meaning of the mark, are affixed to the component. The document D2 discloses a sheet-shaped member affixed to an image forming apparatus, wherein contact information for a consumables supplier and a repair company, and a procedure of removing a sheet involved in a transport trouble, are described in the sheet-shaped member.

A label sheet, such as the decal or the sheet-shaped member disclosed in the document D1 or D2, can be affixed to an apparatus to allow a user to easily learn apparatus information, according to a letter and/or a mark described in the label sheet. However, depending on the method of description, apparatus information described in a label sheet is likely to become hardly recognizable (i.e., legible). Moreover, there is concern that the label sheet is likely to spoil an exterior appearance of an apparatus due to failure in color harmony with the apparatus.

Thus, there is a need for improving visibility (i.e., legibility) of apparatus information described in a label sheet, while preventing the label sheet after being affixed to an apparatus from spoiling the exterior appearance of the apparatus. For meeting this need, it is contemplated that a plurality of colors are used for describing a letter or a mark, or changing a color of an underlying layer of the label sheet. However, the use of a plurality of colors for describing apparatus information in a label sheet or forming an underlying layer of the label sheet leads to an increase in cost and causes a problem about an increase in the number of production processes.

### SUMMARY OF THE INVENTION

It is an object of the present invention to provide an apparatus-information indicator or a label sheet capable of indicating apparatus information, such as a model name, specifications and a disposal procedure, on an apparatus, in such a manner as to allow a user to easily recognize the apparatus information, while suppressing increases in cost and the number of production processes. It is another object of the present invention to provide an electronic apparatus and an image forming apparatus having the apparatus-information indicator or the label sheet in an affixed manner.

In order to achieve the above object, according to one aspect of the present invention, there is provided an apparatus-information indicator which comprises: an indication surface; an underlying segment formed on the indication surface by a first dot pattern; and a character area formed on the underlying segment by a second dot pattern different from the first dot pattern to indicate given apparatus information, wherein respective colors of the underlying segment and the character area are substantially equal in hue, and substantially different in lightness.

According to another aspect of the present invention, there is provided a label sheet which comprises: a first surface adapted to be used as an indication surface, wherein the first surface has a first color; a second surface located on an opposite side of the first surface and adapted to be used as a bonding surface of the label sheet; an underlying segment formed on the first surface by a first pattern using a dot of a second color different from the first color; and a character area formed on the underlying segment by a second pattern different from the first pattern, using the second-color dot, to indicate given apparatus information.

According to yet another aspect of the present invention, there is provided an electronic apparatus which comprises an apparatus body, and an apparatus-information indicator attached to the apparatus body, wherein the apparatus-information indicator has the above features.

According to still another aspect of the present invention, there is provided an image forming apparatus which comprises an apparatus body, and an apparatus-information indicator attached to the apparatus body, wherein the apparatus-information indicator has the above features.

### BRIEF DESCRIPTION OF THE DRAWINGS

FIG. 1 is a perspective view of an image forming apparatus having a label sheet according to one embodiment of the present invention.

FIG. 2 is a front view of the label sheet illustrated in FIG. 1.

### DETAILED DESCRIPTION OF THE PREFERRED EMBODIMENTS

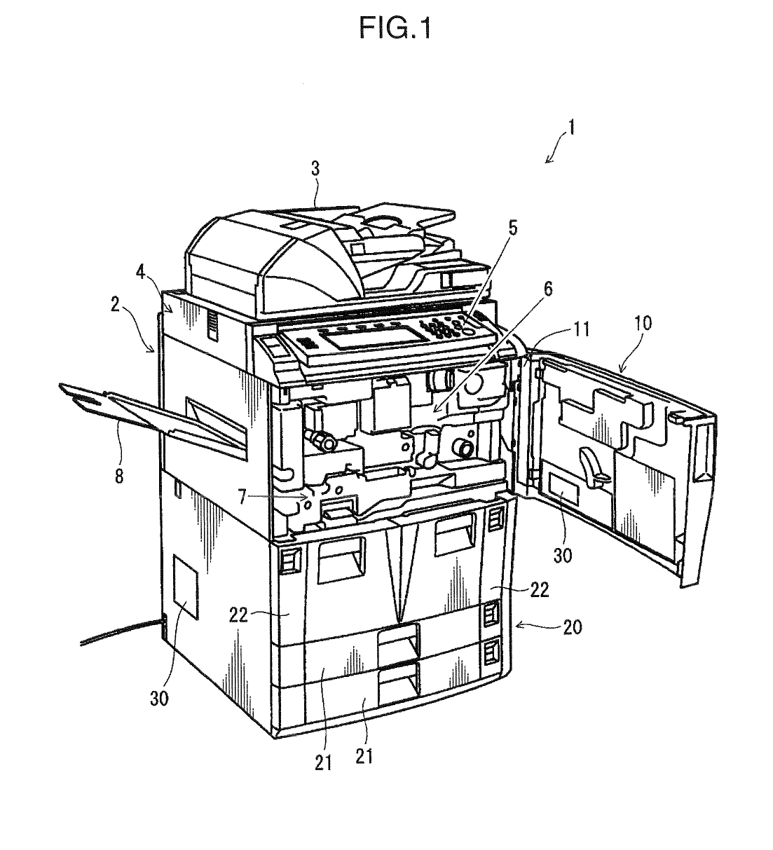

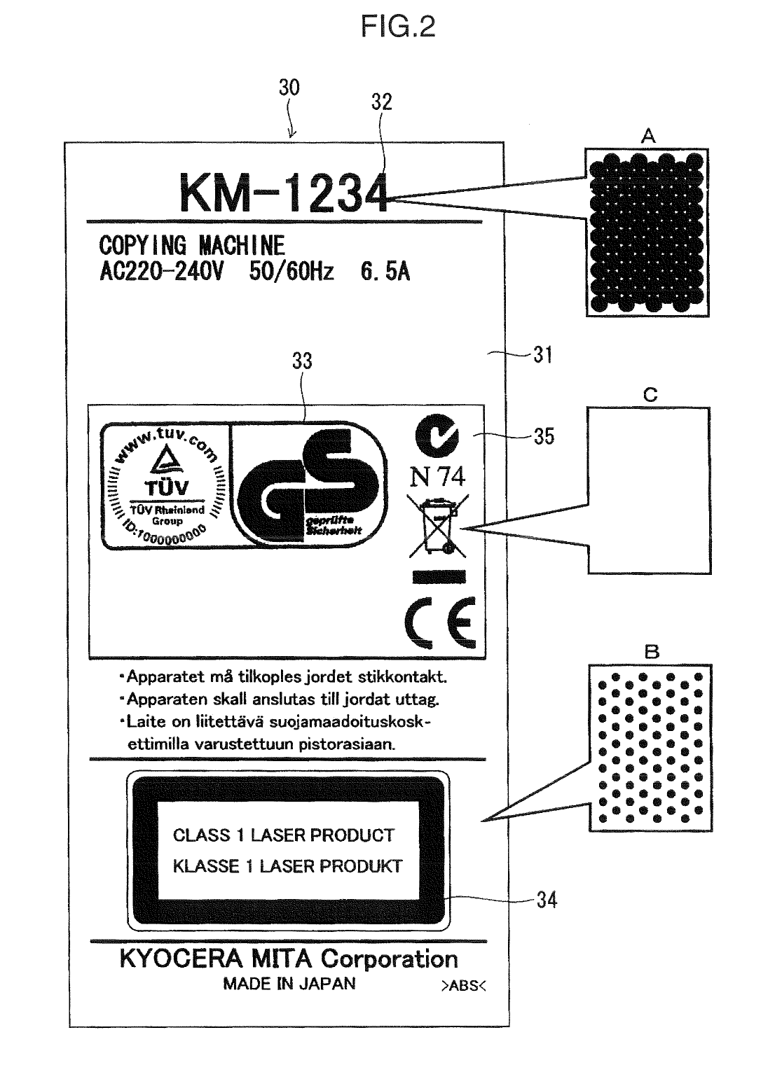

With reference to FIGS. 1 and 2, the present invention will now be specifically described based on one embodiment thereof. The following description will be made by taking an image forming apparatus 1 as one example of an electronic apparatus having a label sheet of the present invention in an affixed manner.

Firstly, the structure of the image forming apparatus 1 will be described with reference to FIG. 1. FIG. 1 is a perspective view of the image forming apparatus 1 having a label sheet according to one embodiment of the present invention, wherein an exterior cover 10 at a front end thereof is in its open position.

The image forming apparatus 1 comprises an apparatus body 2, a document feed section 3 disposed above the apparatus body 2, and an image read section 4 just below the document feed section 3. The document feed section 3 is operable to feed one or more documents one by one in a separated manner, and the image read section 4 is operable to read image data on each of the documents. Then, the image read section 4 is operable to emit a laser beam toward an image forming unit (not shown) of an after-mentioned printing section 6, while controlling the laser beam based on the image data.

The image forming apparatus 1 also includes a manual operation panel 5 disposed on a frontward side of the document feed section 3 at a position allowing a user to externally check a display and manually push buttons. In a document copy mode, after loading the document feed section 3 with a document having an image, such as a letter, a graphic or a pattern, and inputting printing conditions through the manual operation section 5, a user pushes a start button. The image forming apparatus 1 further includes a control unit (not shown) adapted to generally control an image forming operation. This control unit is operable, in response to receiving an instruction from the manual operation panel 5, to start the image forming operation, such as transport of a sheet and formation of a toner image.

The apparatus body 2 of the image forming apparatus 1 has a cassette-type sheet feed section 20 disposed in a lower region thereof The cassette-type sheet feed section 20 includes an ordinary general-purpose sheet feed cassette 21, and a large-capacity sheet feed cassette 22. Specifically, the general-purpose sheet feed cassette 21 consists of two sheet feed cassettes 21 each formed to have the same capacity, and arranged in a vertical direction. The large-capacity sheet feed cassette 22 consists of two feed cassettes each formed to have the same capacity, and arranged at the same height in a horizontal direction. Each of the sheet feed cassettes is adapted to be drawable relative to the apparatus body 2 in a horizontal direction from the side of the front end of the apparatus body 2. A stack of sheets, such as pre-printed cut papers, are received in each of the sheet feed cassettes, and fed upwardly therefrom one by one in a separated manner.

The apparatus body 2 also has a printing section 6 disposed immediately below the image read section 4 and the manual operation panel 5, and above the cassette-type sheet feed section 20. Although not illustrated, the printing section 6 is internally provided with an image forming unit, a transfer unit and a fixing unit.

The image forming unit is operable to form an electrostatic latent image conforming to a document image, according to a laser beam emitted from the image read section 4, and develop a toner image from the electrostatic latent image. Then, the transfer unit is operable to transfer the toner image formed by the image forming unit, onto a pre-printed sheet fed from the cassette-type sheet feed section 20 in a synchronized manner. The fixing unit is provided on a downstream side of the transfer unit in a sheet transport direction. The sheet supporting the un-fixed toner image transferred by the transfer unit is transported to the fixing section. In the fixing section, the toner image is fixed through heating and pressing by a heating roller and a pressing roller.

The apparatus body 2 further has a double-sided printing unit 7 (serving as a two-sided printing mechanism) disposed immediately below the printing section 6 and above the cassette-type sheet feed section 20. In a double-sided printing mode, a sheet discharged from the fixing section after completion of printing of a first surface thereof is transported downwardly to the double-sided printing unit 7. The sheet transported to the double-sided printing unit 7 is changed in transport direction, and re-transported upwardly to the transfer unit of the printing section so as to perform printing of a second surface thereof.

The apparatus body 2 is provided with a sheet tray 8 on a downstream side of the fixing unit in the sheet transport direction and on the side a right lateral end of the apparatus body 2. A sheet which is not transported to the double-sided printing unit 7 after being discharged from the fixing unit, is ejected to the sheet tray 9.

The image forming apparatus 1 includes a plurality of exterior covers each adapted to selectively expose an internal structure of the apparatus body 2 to the outside. For example, one of the exterior covers is an external cover 10 provided in an upper region of the front end of the apparatus body 2, as shown in FIG. 1.

The external cover 10 is disposed in a region of the front end of the apparatus body 2, on an upper side of the cassette-type sheet feed section 20. The external cover 10 is supported by an external frame of the apparatus body 2 through an opening/closing mechanism 11 provided at a right end thereof. The external cover 10 has a left end which is a free end swingably movable about a pivot of the opening/closing mechanism 11 along a horizontal plane while. That is, the external cover 10 is adapted to be selectively openable and closable relative to the front end of the apparatus body 2, wherein it is opened to allow the printing section 6 and the double-sided printing unit 7 as an internal structure of the image forming apparatus 1 to be exposed to the outside, as shown in FIG. 1. For example, a user can open the external cover 10 to handle a sheet jam, or replenish toner.

The above image forming apparatus 1 has a label sheet (apparatus-information indicator) 30 at a desired position of a rear surface of the external cover 10 or a lateral surface of the apparatus body 2. The label sheet 30 is provided as a means to indicate apparatus information, such as names of a manufacturer, a distributor and a repair company, a product name, a model name, performances, functions, specifications, an operation procedure, a procedure for coping with each malfunction, and a disposal procedure, which are associated with the image forming apparatus 1.

The label sheet 30 has a front surface (i.e., indication surface or first surface) printed with a character indicating the apparatus information. For example, the character includes a letter (e.g., alphabetical letter), a symbol (or code or sign), a pictographic character, a mark, a graphic (or figure), a logo (or brand symbol), a picture of a creature or a plant or a virtual representation thereof, and a closing line. The label sheet 30 has a rear surface (i.e., second surface) formed as a bonding surface of the label sheet 30 relative to the external cover 10. For example, the rear surface is affixed to the external cover 10 using an adhesive, or a bonding member such as a double-sided bonding tape.

With reference to FIG. 2, a detailed structure of the label sheet 30 will be described below. FIG. 2 is front view of the label sheet 30, when viewed from the side of the front surface thereof. Each of three boxes (balloons) A to C on the right side of FIG. 2 enlargedly shows the detail of a printed state of a region pointed thereby.

For example, the label sheet 30 is made of a material, such as synthetic resin, metal or paper, and formed in a film shape. The front surface of the label sheet 30 has a color of the material itself, i.e., a background color (first color). The background color is preferably lighter than a color of the external cover 10. In this embodiment, a white color is selected as the background color.

An underlying layer 31 is formed on the front surface of the label sheet 30 by a printing process. As the apparatus information, a first character 32 expressed by a letter, a second character 33 expressed by a symbol or a mark, and a closing line 34 (which are one example of a character area) are formed on respective regions of the underlying layer 31 (i.e., on an underlying segment) by a printing process. The closing line 34 serves as a character adapted to be used for surrounding one or more letter characters which are desired to be particularly emphasized among the apparatus information.

Each of the underlying layer 31, the first and second characters 32, 33 and the closing line 34 is formed by a dot printing process. A dot used in this embodiment has a color (second color) different from the color (first color) of the front surface of the label sheet 30. Further, the dot is plotted at a resolution of 40 to 200 lpi (lines per inch) based on the number of screen lines.

As enlargedly shown in the box A illustrated in FIG. 2, each of the first and second characters 32, 33 and the closing line 34 is formed by relatively large dots or by a dense dot pattern consisting of dots plotted at a relatively high density (i.e., by a second dot pattern or a second pattern). This makes it possible to express a letter, a mark or a line by a positive or distinct color.

By contrast, as enlargedly shown in the box B illustrated in FIG. 2, the underlying layer 31 is formed by relatively small dots or by a thin dot pattern consisting of dots plotted at a relatively low density (i.e., by a first dot pattern or a first pattern), wherein the dot has a hue equal to that of the first and second characters 32, 33 and the closing line 34. That is, despite the hue of the underlying layer 31 which is equal to that of the first and second characters 32, 33 and the closing line 34, the color of the underlying layer 31 can have a lightness (brightness) different from that of the respective colors of the first and second characters 32, 33 and the closing line 34.

Preferably, the lightness of the underlying layer 31 is set to be equal or approximate to that of a portion of the image forming apparatus 30 to which the label sheet 30 is to be affixed (in this embodiment, the rear surface of the exterior cover 10 or the lateral surface of the apparatus body 2). This makes it possible to harmonize the lightness of the underlying layer 31 with a lightness of an affixing portion of the label sheet 30 so as to allow a user to easily recognize a letter or a mark as the apparatus information.

As shown in a vertically central region of FIG. 2, the label sheet 30 further has an information highlighting zone 35 around a character area indicating specific one or more of the apparatus information. The information highlighting zone 35 is formed to have a color having a lightness different from that of respective colors of the underlying layer 31 and the first and second characters 32, 33, by a dot printing process.

In the label sheet 30 illustrated in FIG. 2, as enlargedly shown in the box C, the information highlighting zone 35 is formed by a pattern without plotting any dot during the dot printing process (i.e., by a third dot pattern or a third pattern). Thus, the background color of the front surface of the label sheet 30 is directly exposed in a region corresponding to the information highlighting zone 35, and thereby the information highlighting zone 35 is formed to have a white color. This is one example, and the information highlighting zone 35 is not limited to being formed to have a white color, but may be formed using dots having a size or density different from that of the dots of the underlying layer 31 and the first and second characters 32, 33. In the above manner, the information highlighting zone 35 surrounds and highlights a character area indicating specific one or more of the apparatus information by a technique different from that of the closing line 34.

As described above, the label sheet 30 is formed such that the first and second characters 32, 33 each formed by a dense dot pattern is described in a region of the underlying layer 31 formed by a thin dot pattern, wherein respective colors of the underlying layer 31 and each of the first and second characters 32, 33 and the closing line 34 are equal in hue, and different in lightness. Thus, even if a color for use in indication or labeling is single, a variety of color densities and intensities can be easily expressed by elaborating a dot pattern. This makes it possible to describe the apparatus information in the label sheet 30 while emphasizing and highlighting desired ones of the apparatus information, using a given character without using a plurality of colors.

In addition, the lightness of the underlying layer 31 can be adjusted to allow a color of the entire label sheet 30 to be harmonized with a color of the external cover 10 of the image forming apparatus 1 or the lateral surface of the apparatus body 2. Thus, when apparatus information, such as a model name, specifications and a disposal procedure, is indicated on an image forming apparatus 1, the label sheet 30 can be affixed to image forming apparatus 1 in such a manner as to achieve color harmony with the image forming apparatus 1, and allowing a user to easily recognize the apparatus information, while suppressing increases in cost and the number of production processes.

Furthermore, the label sheet 30 has the information highlighting zone 35 formed by a dot pattern different from that of the underlying layer 31 and the first and second characters 32, 33. This makes it possible to provide enhanced visibility (i.e., legibility) to a character area described in the information highlighting zone 35 to indicate specific one or more of the apparatus information, and call user's attention to the character area. Thus, the user can recognize that the specific apparatus information has a significant meaning different from those of the remaining apparatus information.

The above embodiment has been described based on one example where the label sheet 30 is attached to the image forming apparatus 1. In the image forming apparatus 1, when apparatus information, such as a model name, specifications and a disposal procedure, is indicated thereon, the label sheet 30 can be affixed thereto in such a manner as to achieve color harmony with the image forming apparatus 1 while suppressing increases in cost and the number of production processes. Thus, the image forming apparatus 1 can indicate apparatus information in an easily recognizable (i.e., legible) manner to a user.

The present invention has been shown and described based on one specific embodiment thereof. It is obvious to those skilled in the art that the present invention is not limited to the specific embodiment, but various changes and modifications may be made therein without departing from the spirit and scope thereof as set forth in appended claims.

For example, as to the dot printing process for the label sheet 30, the value of the number of screen lines (dot density), and the size and arrangement pattern of the dots plotted in each of the boxes A to C in FIG. 2, are shown as one embodiment, and the present invention is not limited to the specific example. The dots may be formed to have any other suitable density, size and pattern.

The above embodiment has been described based on the label sheet 30 as one example of an apparatus-information indicator. Alternatively, the apparatus-information indicator may be a three-dimensional member having an indication surface, instead of a sheet. Further, although above embodiment has been described based on the image forming apparatus as one example of an electronic apparatus, it is understood that the present invention may also be applied to any other suitable electronic apparatus, such as an imaging apparatus or a personal computer.

The above specific embodiment primarily includes an invention having the following features.

An apparatus-information indicator according to one aspect of the present invention comprises: an indication surface; an underlying segment formed on the indication surface by a first dot pattern; and a character area formed on the underlying segment by a second dot pattern different from the first dot pattern to indicate given apparatus information, wherein respective colors of the underlying segment and the character area are substantially equal in hue, and substantially different in lightness.

In the apparatus-information indicator of the present invention, even if a color for use in indication or labeling is single, a variety of color densities and intensities can be easily expressed by elaborating a dot pattern. This makes it possible to describe the character area indicating apparatus information, in the indication surface while emphasizing and highlighting desired ones of the apparatus information, without using a plurality of colors. Thus, when the apparatus information, such as a model name, specifications and a disposal procedure, is indicated on an apparatus, the apparatus-information indicator can be affixed to the apparatus in such a manner as to allow a user to easily recognize the apparatus information while suppressing increases in cost and the number of production processes.

Preferably, the apparatus-information indicator of the present invention further comprises an information highlighting zone formed around the character area by a third dot pattern different from the first and second dot patterns, wherein the information highlighting zone has a color with a lightness value different from those of the respective colors of the character area and the underlying segment.

This feature makes it possible to provide enhanced visibility (i.e., legibility) to a character area surrounded by the information highlighting zone, and call user's attention to the character area. Thus, the user can recognize that the apparatus information indicated by the character area has a significant meaning different from those of the remaining apparatus information.

Preferably, in the above apparatus-information indicator, the indication surface has a color with a given lightness, and the third dot pattern is formed substantially without plotting any dot, to allow the information highlighting zone to substantially have the color of the indication surface. According to this feature, the information highlighting zone can be easily formed using a background color of the indication surface.

A label sheet according to another aspect of the present invention comprises: a first surface adapted to be used as an indication surface, wherein the first surface has a first color; a second surface located on an opposite side of the first surface and adapted to be used as a bonding surface of the label sheet; an underlying segment formed on the first surface by a first pattern using a dot of a second color different from the first color; and a character area formed on the underlying segment by a second pattern different from the first pattern, using the second-color dot, to indicate given apparatus information.

In the label sheet of the present invention, a variety of color densities and intensities can be easily expressed by elaborating the first and second patterns using the dot having the second color. Thus, the character area indicating apparatus information can be described in the indication surface while emphasizing and highlighting desired ones of the apparatus information, without using a plurality of colors.

Preferably, in the above label sheet, the first pattern has the dot at a relatively low density, and the second pattern has the dot at a relatively high density. According to this feature, the character area can be emphasized in a simple manner based on a difference in dot density.

Preferably, the above label sheet further comprises an information highlighting zone formed around the character area by a third pattern different from the first and second patterns, using the second-color dot.

This feature makes it possible to provide enhanced visibility (i.e., legibility) to a character area surrounded by the information highlighting zone, and call user's attention to the character area. Thus, the user can recognize that the apparatus information indicated by the character area has a significant meaning different from those of the remaining apparatus information.

Preferably, in the above label sheet, the third pattern is formed substantially without plotting any dot, to allow the information highlighting zone to substantially have the first color. According to this feature, the information highlighting zone can be easily formed using a background color of the indication surface.

An electronic apparatus according to yet another aspect of the present invention comprises: an apparatus body; and an apparatus-information indicator attached to the apparatus body, wherein the apparatus-information indicator includes: an indication surface; an underlying segment formed on the indication surface by a first dot pattern; and a character area formed on the underlying segment by a second dot pattern different from the first dot pattern to indicate given apparatus information, wherein respective colors of the underlying segment and the character area are substantially equal in hue, and substantially different in lightness.

In the electronic apparatus of the present invention, when apparatus information, such as a model name, specifications and a disposal procedure, is indicated thereon, the electronic apparatus can indicate the apparatus information in an easily recognizable (i.e., legible) manner to a user, while suppressing increases in cost and the number of production processes.

An image forming apparatus according to still another aspect of the present invention comprises: an apparatus body; and an apparatus-information indicator attached to the apparatus body, wherein the apparatus-information indicator includes: an indication surface; an underlying segment formed on the indication surface by a first dot pattern; and a character area formed on the underlying segment by a second dot pattern different from the first dot pattern to indicate given apparatus information, wherein respective colors of the underlying segment and the character area are substantially equal in hue, and substantially different in lightness.

In the image forming apparatus of the present invention, when apparatus information, such as a model name, specifications and a disposal procedure, is indicated thereon, the image forming apparatus can indicate the apparatus information in an easily recognizable (i.e., legible) manner to a user, while suppressing increases in cost and the number of production processes.

Preferably, in the image forming apparatus of the present invention, the apparatus body includes an exterior cover, and the apparatus-information indicator is attached to the exterior cover, wherein the lightness of the underlying segment is set to be equal or approximate to that of the exterior cover.

According to this feature, a color of the entire apparatus-information indicator can be harmonized with a color of the external cover of the image forming apparatus. This allows a user to more easily recognize the apparatus information.

This application is based on Japanese Patent application serial No. 2007-206525 filed in Japan Patent Office on Aug. 8, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An apparatus-information indicator comprising:
an indication surface;
an underlying segment formed on said indication surface by a first dot pattern; and
a character area formed on said underlying segment by a second dot pattern different from said first dot pattern to indicate given apparatus information,
wherein respective colors of said underlying segment and said character area are substantially equal in hue, and substantially different in lightness.

2. The apparatus-information indicator as defined in claim 1, which further comprises an information highlighting zone formed around said character area by a third dot pattern different from said first and second dot patterns, said information highlighting zone having a color with a lightness value different from those of the respective colors of said character area and said underlying segment.

3. The apparatus-information indicator as defined in claim 2, wherein:
said indication surface has a color with a given lightness; and
said third dot pattern is formed substantially without plotting any dot, to allow said information highlighting zone to substantially have the color of said indication surface.

4. A label sheet comprising:
a first surface adapted to be used as an indication surface, said first surface having a first color;
a second surface located on an opposite side of said first surface and adapted to be used as a bonding surface of said label sheet;
an underlying segment formed on said first surface by a first pattern using a dot of a second color different from said first color; and
a character area formed on said underlying segment by a second pattern different from said first pattern, using said second-color dot, to indicate given apparatus information.

5. The label sheet as defined in claim 4, wherein said first pattern has said dot at a relatively low density, and said second pattern has said dot at a relatively high density.

6. The label sheet as defined in claim 4, which further comprises an information highlighting zone formed around said character area by a third pattern different from said first and second patterns, using said second-color dot.

7. The label sheet as defined in claim 6, wherein said third pattern is formed substantially without plotting any dot, to allow said information highlighting zone to substantially have said first color.

8. An electronic apparatus comprising:
an apparatus body; and
an apparatus-information indicator attached to said apparatus body, said apparatus-information indicator including:
an indication surface;
an underlying segment formed on said indication surface by a first dot pattern; and
a character area formed on said underlying segment by a second dot pattern different from said first dot pattern to indicate given apparatus information,
wherein respective colors of said underlying segment and said character area are substantially equal in hue, and substantially different in lightness.

9. An image forming apparatus comprising:
an apparatus body; and
an apparatus-information indicator attached to said apparatus body, said apparatus-information indicator including:
an indication surface;
an underlying segment formed on said indication surface by a first dot pattern; and
a character area formed on said underlying segment by a second dot pattern different from said first dot pattern to indicate given apparatus information,
wherein respective colors of said underlying segment and said character area are substantially equal in hue, and substantially different in lightness.

10. The image forming apparatus as defined in claim 9, wherein said apparatus body includes an exterior cover, and said apparatus-information indicator is attached to said exterior cover, wherein the lightness of said underlying segment is set to be equal or approximate to that of said exterior cover.
